(19) United States
(12) Patent Application Publication
(10) Pub. No.: US 2020/0322166 A1
(43) Pub. Date: Oct. 8, 2020

(54) METHOD FOR THE SECURE EXCHANGE OF MESSAGES BETWEEN TERMINAL DEVICES IN A NETWORK

(71) Applicant: OSRAM GmbH, Munchen (DE)

(72) Inventors: Jiye Park, München (DE); Markus Jung, Feldkirchen (DE); Prajosh Premdas, Freising (DE)

(21) Appl. No.: 16/843,038

(22) Filed: Apr. 8, 2020

(30) Foreign Application Priority Data
Apr. 8, 2019 (DE) 10 2019 204 951.6

(51) Int. Cl. H04L 9/32; H04L 29/06

(52) U.S. Cl. CPC H04L 9/3247; H04L 63/0471; H04L 9/3263; H04L 63/0442; H04L 63/0823

(57) ABSTRACT

A method for a secure exchange of one or more messages between terminal devices in a network connecting said terminal devices. The method may include creating a message by a first terminal device, digitally signing the message with a private key of the first terminal device, and transmitting the signed message to at least a second terminal device. The creation of the message to be transmitted and the digital signing may occur before an event relating to an intended interworking of the terminal devices triggers the transmission of the signed message, wherein a content of the created message to be evaluated by the second terminal device is related to the event.

### CROSS-REFERENCE TO RELATED APPLICATION

This patent application claims priority from German Patent Application No. DE 10 2019 204 951.6 filed on Apr. 8, 2019, the entire disclosure of which is incorporated herein by reference.

### TECHNICAL FIELD

The present disclosure relates to a method for the secure exchange of messages between terminal devices having, in particular, low processing capacity in a network. The disclosure also relates, in particular, to corresponding terminal devices of the type used in building automation and/or in smart lighting systems.

### BACKGROUND

The Internet of Things (IoT) enables the networking of physical and virtual things or objects with one another and with the Internet. As well as the corresponding communication modules, objects of this type can also comprise sensors or actuators for this purpose. This also relates, in particular, to the domain of building automation and here, for example, to smart lighting systems also. The individual objects (also referred to below as terminal devices) exchange messages with one another via Machine-to-Machine (M2M) communication in order to guarantee the operation of the system. Distributed systems of this type are generally implemented in a REST (Representational State Transfer) architecture, such as e.g. the World Wide Web, with the HTTP protocol, and consequently, for example, basic client-server principles apply, whereby a server provides a service or resource which can be required or requested by the client.

However, in many domains of the Internet of Things, and particularly in the domain of building automation and/or smart lighting systems, not only the processing and storage capacities of the terminal device, but also the underlying networks are in part subject to substantial restrictions. The restrictions can be caused by costs or space requirement or energy consumption, etc. The communication modules may, for example, have comparatively rudimentary 8-bit microcontrollers with limited RAM and/or ROM memory.

Networks of this type may, for example, be those based on the 6LowPAN (IPv6 over Low power Wireless Personal Area Networks) protocol which are designed specifically for the energy-saving use that is required here. The 6LowPAN protocol provides an adaptation layer at the level of the switching layer in the OSI reference model (Layer 3) which offers e.g. the advantages of a multicasting provided in IPv6 message exchange, but which can simultaneously cope with the restrictions of the underlying physical layer and link layer, e.g. defined according to the IEEE 802.15.4 standard for radio transmission networks, i.e. the first and second layers of the OSI reference model, thus adapting them to the higher application layers.

In the aforementioned systems with a restricted environment, the UDP (User Datagram Protocol) is furthermore normally applied at the level of the transport layer (i.e. Layer 4 of the OSI reference model). This simple protocol is per se connectionless, unreliable, unsecured and unprotected. This protocol does not guarantee that a specific data packet will arrive at the receiver at all, precisely once only and/or at least in the correct sequence with other data packets, or that the data have not been corrupted or that third parties have not had access to the data of the packet. On the other hand, this transmission offers the advantage that no delay occurs in the data transmission, e.g. through a renewed request for lost packets as in the case of the alternative TCP protocol. The network load is thereby minimized. Particularly if low volumes of data are to be exchanged via the network, as in the case of building automation or smart lighting systems in particular, the data throughput is increased.

At the level of the application layer (Layer 5 in the OSI reference model), an application protocol which is referred to as the Constrained Application Protocol (CoAP) and which takes account of the described requirements has therefore been defined by the IETF Constrained RESTful environments (CoRE) working group in light of these restrictions, i.e. resource-restricted devices such as 8-bit microcontrollers with little ROM and/or RAM memory and loss-affected networks with a low transmission rate (Request for Comments 7252; Shelby, Z. et al.; ISSN: 2070-1721; draft dated June 2014 downloadable at https://tools.ietf.org/html/rfc7252). This protocol was developed for use with UDP, but can also be used with TCP or similar protocols. In the case of UDP, a CoAP message occupies the payload field of the UDP datagram. A CoAP itself in turn comprises a 4-byte header, a token, options and finally the actual payload of the application.

The mode of operation of the CoAP protocol is similar to that of the widely known HTTP protocol (Hypertext Transfer Protocol), particularly in terms of the underlying client/server model. A CoAP request is transmitted, for example, by the client in order to request an action lying within the action area of the server on the basis of a resource identified by a URI (Universal Resource Identifier) using a method code in the corresponding message. The server then transmits a message with a response which is identified by a response code.

Since the CoAP protocol, unlike e.g. HTTP, provides only an asynchronous and therefore possibly unreliable communication between the client and the server via the exchange of UDP datagrams, a messages layer is incorporated within the CoAP application layer as a type of subdivision, said messages layer defining four message types: “confirmable”, “non-confirmable”, “acknowledgement” and “reset”. With these message types, for example depending on the case, the reliability of the message exchange can optionally be re-established at a higher layer level on the basis of the “confirmable” type by requesting a confirmation message with the “acknowledgement” type (or alternatively in the case of problems: with the “reset” type). A congestion resolution mechanism can also be provided here (in the absence of a confirmation) using Binary Exponential Backoff in each case with predefined retransmission in each case after e.g. a doubling delay time.

Along with the messages layer, a request/response layer is also incorporated as a subdivision of the CoAP application layer. A close relationship exists here with the HTTP protocol, so that a transfer of applications from the HTTP into the CoAP is easily possible. Information indicating whether the message concerned is a request or a response is stored in each case in a 1-byte code field in the header of the CoAP message. Information indicating whether e.g. the request method is a GET, a POST, a PUT or a DELETE is further stored in the same field. These methods are also used e.g. accordingly in the HTTP also. Codes which are assigned in each case to one of the classes: “Success”, “Client Error” or “Server Error” are similarly provided for responses.

The DTLS (Datagram Transport Layer Security) encryption protocol can be used in order to solve the problems described above in the case of restricted networks relating to reduced security and unreliable data transmission. In contrast to the TLS protocol which is used in the case of the more reliable HTTP-over-TCP use, the exchanged messages are, for example, explicitly numbered and missing messages are automatically retransmitted after a timeout in the case of DTLS. The correct sequence and the handshake between the client and server are thereby secured in the respective communication.

However, neither TLS nor DTLS can be used in a multicast. In accordance with the protocol, TLS or DTLS encryptions also always end at the respective proxies, so that the respective proxies themselves can access and, if necessary, modify the protected contents concerned. However, multicasts are a vital requirement, particularly in the case of a group communication of the type that is used, in particular, in building automation networks and here, in particular, in smart lighting systems.

The aforementioned CoRE Working Group is therefore currently working on a draft for a new method of protecting the application layer operated under the CoAP protocol, said method being designated by the acronym OSCORE (Object Security for Constrained RESTful Environments, Internet draft dated Aug. 31, 2018, Selander, G., et al. https://tools.ietf.org/pdf/draft-ietf-core-object-security-15.pdf). The OSCORE security protocol is based on an encryption of exchanged CoAP messages, wherein, inter alia, the payload, specific options and the fields of the header of the original CoAP message are packed into an encrypted object (COSE object; CBOR Object Signing and Encryption) and are then themselves re-attached as payload of the OSCORE message which again essentially has the format of a CoAP message, wherein “OSCORE” is registered as one of the options of this message.

Building on this, the CoRE Working Group is also working on a draft for the protection of group communication using the OSCORE security protocol. This mode of operation is referred to as “Group OSCORE” (Internet draft dated Oct. 22, 2018; Tiloca, M. et al.; https://tools.ietf.org/html/draft-ietf-core-oscore-groupcomm-03). This draft describes how, similar to simple unicast communication between two specific terminal devices, security and integrity can now also be established according to OSCORE in the message exchange between a transmitting terminal device and a group of receiving terminal devices and vice versa. In particular, a sender authentication of all CoAP messages exchanged in the group of more than two terminal devices is enabled by means of digital signatures. This now enables e.g. identification of the terminal device, out of a multiplicity of terminal devices in the group, which issued the response to a message previously sent to all terminal devices. Consequently, group communication can now be performed in a protected manner through this sender authentication.

However, according to the Group OSCORE Internet draft, for example, the special signature algorithm Ed25519 from the EdDSA family is prescribed. This algorithm is particularly efficient and fast and is furthermore patent-free, but is currently available only as a software implementation. Hardware modules are not currently available. A problem now arises in that, if a terminal device is prompted to send a message provided with a signature to the group, the signature algorithm must first be executed at precisely this moment for the encryption by the processor of the communication module before e.g. the aforementioned OSCORE can be dispatched. However, precisely in the restricted environment described above (constrained devices, constrained network) with e.g. 8-bit microcontrollers, this additional signature calculation phase can result in particularly unwanted latency times. According to a comparative example with a typical controller of this type (e.g. TI CC2538DK with ARM Cortex-M3, 512 kb Flash and 32 kb RAM memory), the key generation can take 4 s, the signing 5s and the verification in the receiver 12s. However, precisely in the building automation domain and/or in smart lighting systems, corresponding latency times are unacceptable. In the case of smart lighting systems, latency times, for example, of 200 ms or less are just about acceptable.

One possible solution would be to provide more powerful controllers and communication modules. However, this would drive up energy consumption and, in particular, costs in a manner that is no longer acceptable due to the multiplicity of modules to be adapted. The present Group OSCORE draft further provides simply to exclude those terminal devices which are not able to perform precisely that signature verification. In this case, the transmitting terminal device can/should characterize the CoAP messages as “non-confirmable”, but this then switches the receiving terminal device to a passive role (“pure listener”).

However, this again also characterizes only a less desired state and furthermore reduces the security and reliability of the message exchange.

### SUMMARY

One object is to provide a method and/or a correspondingly configured terminal device with which a particularly secure message exchange can be guaranteed even in networks with terminal devices having low processing capacity, and in which the costs and complexity of providing the message exchange can be minimized.

The object is achieved by a method for the secure exchange of one or more messages between terminal devices in a network connecting said terminal devices having the features of claim 1, and by a correspondingly configured terminal device having the features of claim 15. Advantageous developments, designs and aspects are indicated in the dependent claims.

The starting point is a method for the secure exchange of one or more messages between terminal devices in a network connecting said terminal devices, comprising the following steps: creation of a message by a first terminal device, digital signing of the message with a private key of the first terminal device, and transmission of the signed message to at least a second terminal device. This may involve a conventional client/server communication wherein, for example, the first terminal device represents a client which incorporates a request into the message which could then be answered by the second terminal device as the server (response), for example by providing a resource, etc., or merely by means of a simple acknowledgement of receipt of the message. However, the first terminal device may, for example, also be a server which provides the resource with the signed message or transmits the acknowledgement to a preceding request, etc.

The message is not restricted to specific protocols. It is implemented at the level of the application layer. It may comprise a message header and a message body. The message header can contain information relating to the message type, versions of the underlying protocol, field lengths in the message body and/or identification numbers relating to this message, etc. The message body can contain the actual payload, options and information relating to the payload and/or identification numbers relating to the specific message exchange, part of which is the current message, etc.

The terminal devices can in each case have a communication module or controller connectable to the network, and also a functional unit which is used for the intended purpose, in the case of a smart lighting system, for example, a light, a sensor, a control device, an actuator, etc. The communication module is considered below as part of the functional unit.

The network can be cable-connected and/or wireless. Furthermore, no restrictions in terms of the structure or architecture/topology are defined. A network in the sense used here may be a LAN, WPAN or WLAN, or furthermore a building network or corporate network extended by routers, switches and/or repeaters, an Intranet or the Internet as a whole, etc.

According to non-limiting embodiments, it is now provided to carry out the steps of creating the message to be transmitted and the digital signing by the first terminal device before an event relating to the intended interworking of the terminal devices triggers the transmission of the signed message. A content of the created message which is to be evaluated by the second terminal device is related precisely to this event.

An event-related message exchange is therefore assumed here. An event is to be understood here as a change of (any type of) state at a specific time. Since, considered logically, it triggers the dispatch of the message, along with the change of state itself, it may also entail the conversion into a pulse or signal which can be processed by the communication module as the triggering mechanism. The event may be a change of a physical state detected by a sensor or by a measuring device, said change being converted accordingly into a signal. The event can be regarded as an understepping or exceeding of a predefined limit value for a physical, chemical or mathematical variable, etc. The event may also be an alarm signal, i.e. a change from an ordinary operational state to an extraordinary operational state. The event may also consist of a request which is received with a message, whereby a state changes from “all requests answered” to “requests open”. The event begins here with the message reception.

A causal relationship consequently exists between the event and the dispatch of the message. The message content relates to the event, wherein, for example, a request transmitted with an earlier message is answered with an acknowledgement in the current message, or a value of a physical variable whose state has changed is transmitted in the payload part of the message, or a request is transmitted with the message, requiring an action on the part of the receiving second terminal device as a result of the change of state, etc.

However, the creation and, in particular, the complex signing of the message are carried out in the first terminal device itself before the occurrence of the event, i.e. the change of state with corresponding signal reception. This may imply that the first terminal device can make a certain prediction that a specific event will be the next event to occur. However, it is also possible without an actual prediction, e.g. if there are only a very limited number of possible events, particularly in the case of switching procedures (“ON” or “OFF”), etc., simply to create all possible messages in advance and, in particular, to sign them digitally and then hold them until they are dispatched, wherein the correct message can finally be selected.

In any event, these designs offer a particular advantage in that the processing time required for the signing in the communication module or the controller of the terminal device does not occur until the event takes place, but can be brought forward, for example, into a preceding idle phase of the first terminal device or its controller. The response of the terminal device to the event in the form of a message communication is thereby significantly faster, and the latency time of the system become shorter. This advantage is noticeable particularly if, as is normal in building automation and/or in the case of smart lighting systems, microcontrollers with low processing and/or storage capacities are used. The proposed method now makes it possible for the first time in many systems to carry out a message exchange with digital signing for authentication.

According to one advantageous development, the first terminal device comprises a sensor in the proposed method. The event corresponds to a change of a state in an environment of the sensor detected by the sensor. Messages from sensors should be transmitted particularly quickly, especially in building automation or in the case of smart lighting systems, for example if a lighting is to be adapted to the presence and, if necessary, also the distribution of persons in a room. Excessively long latency times could otherwise adversely affect the provision of appropriate lighting for the persons concerned.

According to one development, the first terminal device is designed to precalculate the subsequently occurring event and/or the message relating to the event. The first terminal device can, for example, perform the precalculation by creating a list of essentially possible events or messages and by selecting from said list, through comparison with the last-occurring event or the last-transmitted message, the event which is certain to occur or which will occur at least with a minimum probability as the next event or the message relating thereto. The method is based here in principle on a step in which a check is carried out to determine whether any prediction at all can be made concerning the event which will be the next to occur. This generally requires a definitive list or a limited number of possibilities for events in relation to the first terminal device concerned or messages relating thereto (and also the fact that only one specific message is allowed to be created uniquely for one specific event). In a simple case in which only two states can occur, as in the case of a switch, the precalculation entails, for example, the determination of the two possible events, the determination of the current state or the last event and the consequent selection of the only possible other event with a subsequent calculation or composition of the message.

However, the precalculation can also be designed to be more complicated if more than two possible events can occur and a plausibility or probability calculation is performed for the events on the basis of the current state or the last event or even the last events in a sequence, wherein a comparison with final selection can also be included here. A next event, for example, can be inferred from the sequence of last events through corresponding calculation. However, if said event does not occur, but a different event occurs instead, the message created in advance and digitally signed can be discarded and a new message is nevertheless created, digitally signed and dispatched as in the conventional case after the occurrence of the event. A latency time then still occurs once more, but, even in this case, at least the majority of cases can still be processed due to the previously performed prediction and probability calculation. In other words, even the case of a plurality of selection options is possible by the methods and devices described herein.

According to a further advantageous development, the first terminal device can store the signed message relating to the event until the occurrence of the event. It then retrieves the message and transmits it to the second terminal device when the event occurs. This aspect is advantageous if, in particular, longer idle times occur or if, e.g. for two or a few more possible changes of state or events, the corresponding messages are already precalculated when the system starts, so that the respective repeated recalculation can be foregone.

According to a further advantageous development, the first terminal device carries out the steps of creating and signing the message immediately after a further message relating to a preceding event has first been dispatched. The prediction or the prior creation and signing of the previous message can require a normal stimulus or trigger point, wherein the dispatch of the previous message is selected here as the trigger. Alternatively, this is done within an idle phase between the dispatch of two messages. Since the time of the subsequent event is not known, an early trigger point within the idle phase consequently offers advantages.

According to a further development, the terminal devices, including the first and the second terminal device and the network connecting them, are part of a smart building automation and/or lighting system and form a group for secure communication. The digitally signed message is transmitted from the first terminal device in a multicast to all further terminal devices, including the second terminal device. As described, a multicast communication is an existing requirement, particularly in smart building automation and/or lighting systems, but it imposes increased requirements in terms of the security and reliability of the network communication. The digital signature (and verification) which are difficult for controllers with low processing capacity can therefore nevertheless be advantageously implemented by means of the solution.

According to a further advantageous special development, the sensor comprises a presence detector to detect a presence of persons in an environment of the presence detector. The second terminal device comprises, for example, a light which is operated depending on messages from the presence detector. The event corresponds to the detection of the entry or exit of one or more persons into or from the environment of the presence detector. In the case where the last-occurring event corresponds to the detection of the entry of the one or more persons, the first terminal device then selects, as the next event to occur for which the message is to be created, a correspondingly complementary event which corresponds to the detection of the exit of the one or more persons from the environment before it occurs. The presence detection or person detection represents a case with particular requirements for short latency times, so that the proposal offers particular advantages here.

According to a further advantageous special development, the sensor comprises a temperature sensor to indicate a temperature. The second terminal device further comprises an air conditioning system which is operated depending on the contents of the relevant messages from the temperature sensor. The event corresponds here to a detection of the exceeding or understepping of a predefined temperature limit value. The first terminal device precalulates, through extrapolation, the next event to occur for which the message is to be created, before it occurs, from at least one last-occurring event of detecting that a further, lower or higher predefined temperature limit value has been exceeded or understepped. This corresponds to an advantageous example embodiment in which a plurality of different events can occur (the temperature e.g. does or does not increase further).

According to a further advantageous development, messages are exchanged according to the method in the network at the application layer in accordance with the Constrained Application Protocol, CoAP, defined in RFC7252, based on the transport layer according to the User Datagram Protocol, UDP, defined in RFC768. As described above, this protocol represents a particularly appropriate platform for the message exchange in systems with terminal devices which have only a limited processing and/or storage capacity, as in the case of building automation or in smart lighting systems.

According to a further advantageous development, the message is digitally signed with a signature algorithm based on elliptic curves, in particular ECDSA or Ed25519. These methods offer a particularly high degree of security against decryption-based attacks, but they also require certain processing capacities which can, however, be used intelligently by the proposed method.

According to a further advantageous development, the digitally signed message is additionally encrypted with an open key accessible to all terminal devices in the group. This further increases the security of the message exchange. The corresponding calculation can similarly be performed with the same advantages as described before the occurrence of the event or the change of state.

According to a further advantageous development, the second terminal device receives the digitally signed message and, in a further step, verifies the digital signature of the first terminal device, wherein the second terminal device carries out the same steps as the first terminal device accordingly before or after the reception of the digitally signed message from the first terminal device, provided that the event concerned is the reception of the digitally signed message from the first terminal device itself. In other words, the second terminal device creates a further message relating to the response to the digitally signed message from the first terminal device and signs it digitally, even before it receives the digitally signed message from the first terminal device. The second terminal device then transmits this further digitally signed message back to the first terminal device depending on the reception of the digitally signed message from the first terminal device.

Through this approach, the proposed procedure is extended over the entire communication between the terminal devices, i.e. the request and response, so that latency times are even more extensively avoided and costs for higher-performance controllers which would otherwise be required are further avoided.

According to a further advantageous development of this aspect, the further digitally signed message is a simple acknowledgement of receipt of the digitally signed message from the first terminal device without payload. The requirement to dispatch a message of this type is also frequently present in the Constrained Application Protocol, CoAP, defined in RFC7252, if requests are of the “confirmable” type, so that a retention of the corresponding, already digitally signed, messages offers further advantages.

A terminal device for the secure exchange of one or more messages with further terminal devices in a network connecting said terminal devices is also provided, wherein the terminal device is designed to create a message, to digitally sign this message with a private key and to transmit the digitally signed message to at least a second terminal device. The terminal device is now designed to create and digitally sign the message to be transmitted before an event relating to the intended interworking of the terminal devices triggers the transmission of the signed message, wherein a content of the created message to be evaluated by the second terminal device is related to the event. The same advantages are offered as those described with reference to the method and its developments.

The first terminal device is designed, for example, to precalculate the subsequent occurring event and/or the message relating to the event.

The first terminal device can further be designed to perform the precalculation, the creation and the digital signing of the message in an idle phase of the terminal device.

Further advantages, features and details can be found in the claims, drawings, the following description of embodiments and with reference to the drawings. The same reference numbers denote the same features and functions in the figures.

### BRIEF DESCRIPTION OF THE DRAWINGS

Further advantages, non-limiting embodiments and refinements of the semiconductor chip and of the method may be found from the various embodiments explained below in connection with the figures, in which:

FIG. 1A shows a schematic representation of an overview of a network in which a first terminal device transmits a multicast message to further terminal devices in the same group;

FIG. 1B as in FIG. 1A, wherein the further terminal devices transmit an acknowledgement back to the first terminal device;

FIG. 2 is a flow diagram showing the sequence of an exchange of signed messages between terminal devices in the group according to a conventional approach;

FIG. 3 is a flow diagram showing the sequence of an exchange of digitally signed messages between terminal devices in the group according an embodiment;

FIG. 4 is a flow diagram showing the block 40/50 from FIG. 3 in detail;

FIG. 5 is a schematic diagram with captured measured values for the presence P of persons in a room from a presence detector, plotted against time t;

FIG. 6 is a schematic diagram showing captured measured values of the temperature T by a temperature sensor, plotted against time t,

FIG. 7 shows a schematic representation of the structure of a CoAP message.

Elements which are the same or of the same type, or which have the same effect, are provided with the same references in the figures. The figures are respectively schematic representations and therefore not necessarily true to scale. Rather, relatively small elements, and in particular layer thicknesses, may be represented exaggeratedly large for illustration.

### DETAILED DESCRIPTION

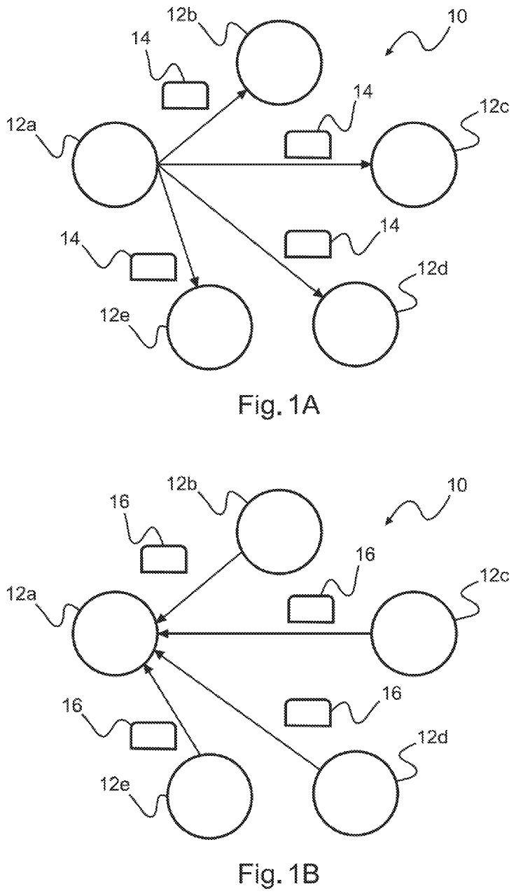

FIGS. 1A and 1B first show schematically, purely by way of example, a situation in which a non-limiting embodiment is based in a (here) wireless or cable-connected (lines not shown) radio network 10 which connects a group of terminal devices 12a, 12b, 12c, 12d and 12e. Without restricting generality, this may be a network 10 of a smart lighting system or building automation system. The terminal devices can comprise the functional unit required in each case for the intended interworking in the lighting or building automation system (e.g. lights, sensors, control devices, actuators for shutters, etc.) and also communication modules with controllers and antennas, in each case including, if necessary, power supply, etc. (not shown), by means of which the terminal devices can communicate with one another.

The terminal devices or their communication modules in each case contain 8-bit microcontrollers with e.g. 512 kb Flash and 32 kb RAM or similar. According to current standards, these terminal devices are referred to as “constrained devices” in view of their comparatively low processing and storage capacity for performing communication tasks, wherein the indicated dimensioning can, however, also be designated as currently completely conventional. The communication in the network is accordingly performed, purely by way of example, on the basis of the Constrained Application Protocol (abbreviated to CoAP) adapted thereto, which is defined in the document RFC7252. CoAP builds in the transport layer on the User Datagram Protocol (abbreviated to UDP) according to the standard defined in the document RFC768, similarly adapted to this situation.

FIG. 1A shows that a first terminal device 12a transmits a request in a CoAP message 14 transmitted as a multicast to all four other terminal devices 12b-12e and consequently identical. The CoAP message comprises a message header and a message body which also contains the payload and carries the actual (semantic or meaningful) content. In the example, the message and, in particular, the payload contain, for example, a change of state detected by the first terminal device 12a as a sensor, for example information indicating that a room covered by the lighting system has been entered by a person, so that the terminal devices 12b-12e need to be activated as lights as a result of the message. It is irrelevant here whether the first terminal device transmits only the information relating to the corresponding event (“person enters room”) as such or already transmits the specific content of the request (“light ON”). The event can be interpreted in the transmitter or in the receiver.

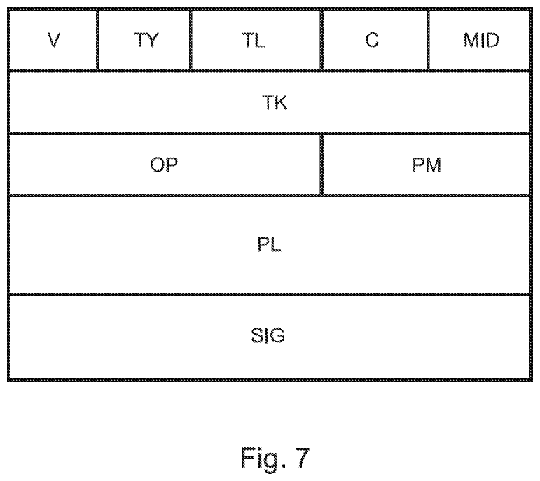

The CoAP message 14 is sent as “confirmable”, which can be defined by means of a corresponding entry in the field T (cf. FIG. 7) of the message header characterizing the message type. The receivers, i.e. the terminal devices 12b-12e, are thereby prompted to transmit a response with the content of a simple acknowledgement (of receipt of the message 14) in order to ensure the reliability of the message transmission. The transmission of the four CoAP response messages 16 from the further terminal devices 12b-12e to the first terminal device 12a is shown in FIG. 1B.

FIGS. 1A and 1B illustrate that, in a case where not all of the terminal devices 12b-12e, but only a subgroup consisting here of 1, 2 or 3 terminal devices, was addressed by the first message 14, a problem can arise in that the first terminal device cannot distinguish which CoAP response message came from which of the terminal devices 12b-12e, i.e. the responses cannot always be easily assigned to the terminal devices. In the case of simple acknowledgement with responses from only three terminal devices in the example shown in FIG. 1B, it can in some instances be left open which terminal device is not capable of responding. In order to enable a unique identification and furthermore falsification-proof assignment in such cases, the message exchange is therefore carried out with authentication and digital signature.

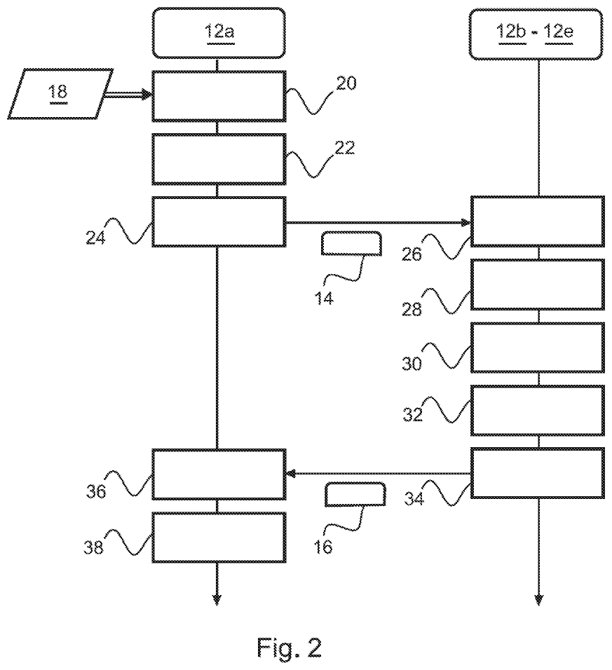

A temporal sequence of the message exchange with digital signature according to a conventional procedure is shown in the flow diagram in FIG. 2. The sequence on the side of the first terminal device 12a is shown on the left, and the sequence on the side of the further terminal devices 12b-12e shown on the right. In the example of the first terminal device 12a designed as a sensor (e.g. presence detector), an event 18, for example, occurs in that the room covered by the smart lighting system is entered by a person. The event 18 designates the change of state from “no person present” to “person present”. The sensor detects this change of state and prompts the communication module or controller (e.g. by means of a signal) to create the CoAP message (step 20) shown above bit-by-bit, wherein the corresponding meaningful content, for example “light ON”, is incorporated in coded form into the field PL with the payload.

In the following step 22, a digital signature is calculated for the created CoAP message by the first terminal device 12a using a private key assigned only to this terminal device and said digital signature is attached to this field PL as a further field SIG (see FIG. 7).

In step 24, the CoAP message 14 digitally signed in this way is sent by the first terminal device 12a, as shown in FIG. 1A.

In step 26, the further terminal devices 12b-12e receive the signed message 14 and, in step 28, these terminal devices 12b-12e in each case verify the signature or authenticate the message as the message actually originally dispatched by the first terminal device 12a. In step 30, the terminal devices 12b-12e in each case create their CoAP response message 16 and, in step 32, for their part calculate a digital signature using a private key in each case assigned only to these terminal devices, and attach said signature to the message. These CoAP messages 16 which differ by dint of their different signatures are transmitted back in step 34. The return transmission is not performed as a multicast.

In steps 36 and 38, the first terminal device 12a receives the CoAP response messages 16 and verifies the signature or authenticates the messages as originating from the further terminal devices concerned.

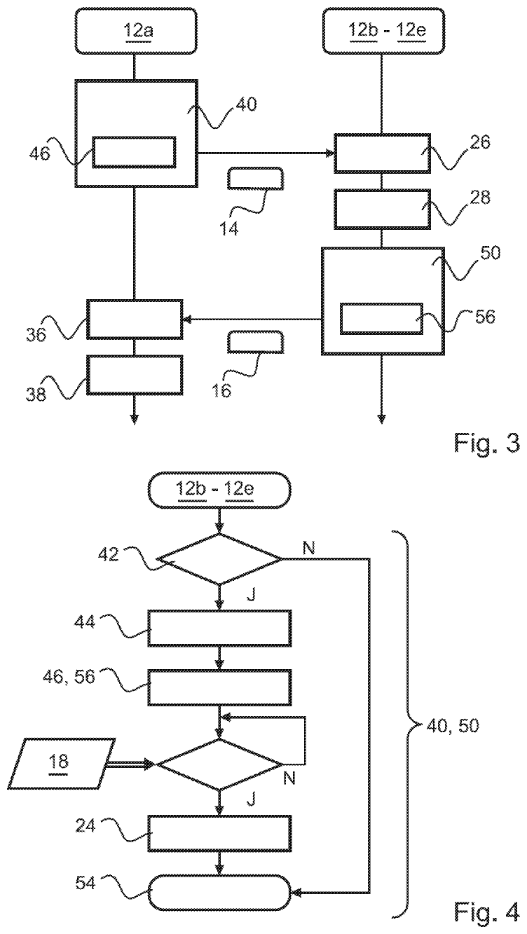

FIGS. 3 and 4 show a corresponding sequence of the exchange of digitally signed messages according to one special example embodiment. The embodiment is based on the situation shown in FIGS. 1A, 1B and 2, so that only the additional steps or the modifications are described. FIG. 3 shows that e.g. the steps 20, 22 and 24 of creating, signing and dispatching the CoAP message 14 in a multicast are replaced by a modified block 40 in which a CoAP message 14 now prepared “in advance” is sent by the first terminal device 12a. The block 40 is shown in more precise detail in FIG. 4. The steps 30, 32 and 34 of creating, signing and dispatching the CoAP message 14 in each case in a unicast are replaced by a correspondingly modified block 50 on the side of the further terminal devices 12b-12e also (cf. similarly FIG. 4).

With reference to FIG. 4, a check is carried out in a step 42 by the first terminal device 12a or by a second terminal device of the further terminal devices 12b-12e to determine whether an event occurring as the next event, a corresponding change of state or an associated message is predictable. In the aforementioned case of the presence detector as a sensor in the first terminal device, this can be confirmed (Y) with some certainty since there are only two states complementary to one another with corresponding events (person present or no person present or “light ON” or “light OFF” message). In the case of a different sensor whose currently represented state allows no inferences to made regarding a next message, the check would result in a “NO” (step 42: N), so that a switch to a conventional message creation according to FIG. 2 would take place. The block 40 (or 50) would be abandoned here (not shown).

If the prediction of the next CoAP message 14 is possible (Y), this is precalculated in the following step 44 even though the event 18 relating to the intended interworking of the terminal devices (i.e. here the indication of the change of state for the light control) has not yet occurred at all. In the next step 46, a digital signature SIG is calculated for the CoAP message 14 and is attached to the latter at the end of the payload part PL (cf. FIG. 7). The digitally signed CoAP message 14 is then stored in the RAM (not shown in FIG. 4).

In step 48, a recursive check is carried out to determine whether the event 18 underlying the precalculated, signed CoAP message has occurred (“is triggered”). If the event 18 then occurs (result Y), the method proceeds to the next step 24 in which the stored, digitally signed CoAP message 14 is retrieved from the memory and the digitally signed CoAP message 14 is then dispatched in the conventional manner. The block 40 (or 50) ends in step 54.

The digital signature SIG is similarly first verified in the conventional manner on the receiver side (terminal devices 12b-12e) following the reception (step 26 as above) of the digitally signed CoAP message 14 in step 28. The steps of the modified block 50 are then performed (see FIG. 4), wherein the response can also be encrypted in advance (step 56). FIG. 4 does not show here that the simple acknowledgement of receipt of the message 14 also contains a CoAP response message 16 which is predictable as such and can be generated, signed and stored for retrieval even before the receipt of the CoAP message 14, i.e. the receipt of the CoAP message 14 itself represents the triggering event 18. Conversely, FIG. 4 shows in block 50 a message creation which is based on an event 18 which does not occur until later (i.e. following receipt of the message 14) and which is to be reported back in the response.

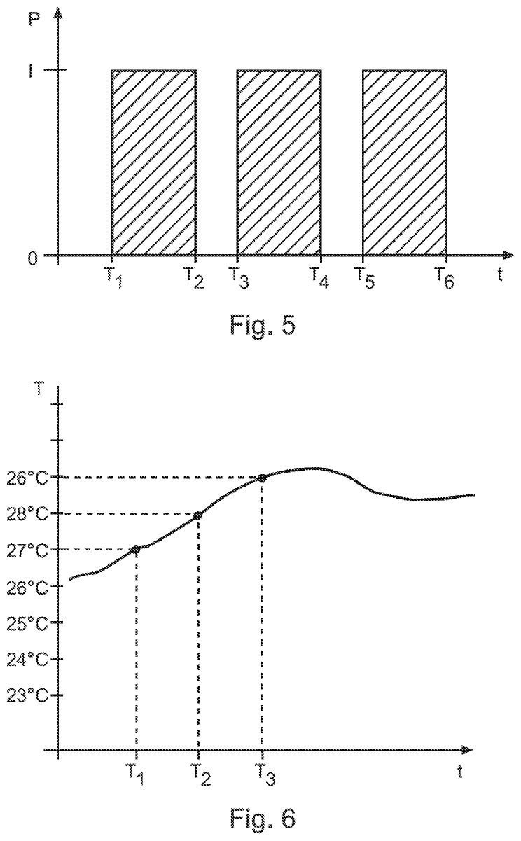

How the block 40 (or 50) shown in FIG. 4 is initiated is explained with reference to FIG. 5. It is clear that the steps 42, 44 and 46 (or 56) with the prediction/precalculation, creation and signing of the CoAP message are carried out before the occurrence of the event 18. In the present case involving the presence detector as a sensor in the first terminal device 12a, there can be only two states as described, this being indicated in FIG. 5 in binary form by “0” and “1” on the y-axis representing the person presence P. On the y-axis, the times T1, T2, T3, . . . designate events 18, i.e. changes of state for which persons have entered or left the room concerned.

At time T1, a (“preceding”) CoAP message 14 is sent by the first terminal device 12a to the further terminal devices 12b-12e, indicating the entry into the room (content: “light ON”). Following the dispatch of the preceding CoAP message 14 (step 24 in FIG. 4), steps 42, 44 and 46 are carried out immediately thereafter instead of the idle time following for the first terminal device 12a in which it waits for responses. In the present case, step 42 leads with the check result Y to create a next CoAP message 14 whose complementary content signifies “light OFF”. This is then immediately digitally signed and stored for the remaining idle time or waiting time until its retrieval following the occurrence of the event 18. The event T2 corresponds here to the predictable next event 18. The procedure continues following the further dispatch with the event times T3, T4, etc.

FIG. 6 shows another non-limiting embodiment. The sensor of the first terminal device 12a is a temperature sensor which is intended to contribute to the control of an air conditioning system (as the further or second terminal device) in a building automation system. The temperature sensor indicates via CoAP messages 14 that temperature limit values have been reached or exceeded. Here, the temperature sensor detects a temperature rise. The intended interworking of the terminal devices provides for the air conditioning system to be activated as from 28° C. by means of an “air conditioning system ON” message. For steps 42, and 46, the first terminal device 12a does not detect the dispatch of the previous message as the trigger here as in the above embodiment, but instead detects a lower pre-limit value which is set here to 27° C. The exceeding of this limit value therefore serves here to instigate the precalculation, creation and digital signing of the CoAP message 14 to be carried out in advance. Here, the precalculation or prediction already also entails a probability of the occurrence of the event which, in some instances, is no longer 100%, since the temperature may also fall once more after exceeding the limit value of 27° C. Conversely, if the actual temperature limit value of 28° C. is the only predefined threshold for the activation or deactivation of the air conditioning system, i.e. if there are no further stages, there can also be only two events, i.e. the exceeding or understepping of said limit value, so that the prediction of the next event is then unequivocal.

A non-limiting example of the structure of the created and signed CoAP message 14 is shown in FIG. 7. The message header consists of the top row in FIG. 7 with: a protocol version V (2 bits), the message type TY (2 bits), a token length TL (4 bits), a code C (8 Bit) and a message ID MID (16 bits), i.e. 32 bits in total. The protocol version V is currently binary “01”, the message type TY, as described above, indicates whether the message is e.g. “confirmable” (binary “00”) or “non-confirmable” (binary “01”). The token length TL can be variable and can comprise up to 8 bytes, whereas the possible values from 9 to 15 are considered as format errors. The code C indicates whether the message is a request or a response, wherein the 3 more significant bits contain the class (e.g. request: binary “000”) and the remaining 5 bits contain the detail, e.g. request methods such as “GET” (binary “00001”) or “POST” (binary “00010”). The message ID MID indicates the unique identification number within an exchange procedure.

The message body comprises the token TK with the token length TL indicated in the header. The token TK is an identification number characterizing the respective message exchange as such. This is followed by the options OP in which bundles of request or response parameters are stored. This is followed by a defined payload marker PM (8 bits) which characterizes the end of the options and marks the beginning of the payload PL. The data of the digital signature SIG then follow, strictly speaking as part of the payload PL, in accordance with Group OSCORE.

It should be noted that the embodiments described above represent special embodiments and do not limit the scope of protection defined by the attached claims. In particular, individual features of the individual example embodiments can also be combined into respectively different example embodiments or modifications.

### REFERENCE NUMBER LIST

10 Network
12a First terminal device
12b-12e Second terminal device, further terminal devices
14 Message, digitally signed CoAP message (Request)
16 Message, digitally signed CoAP message (Response)
18 Event
20 Creation of the message
22 Signing of the message
24 Dispatch of the message
26 Reception of the message
28 Verification, authentication
30 Creation of the message (2nd terminal device)
32 Signing of the message (2nd terminal device)
34 Dispatch of the message (2nd terminal device)
36 Reception of the message (1st terminal device)
38 Verification, authentication (1st terminal device)
40 Block with steps for message creation in advance
42 Prediction, precalculation
44 Creation of the message in advance
46 Signing of the message in advance
48 Checking for occurrence of event
50 Block with steps for message creation in advance
56 Signing of the message in advance
C Message code
MID Message ID
OP Options
PM Payload marker
PL Payload
SIG Digital Signature
TK Token
TL Token length
TY Message type
V Version

What is claimed is:

1. A method for the secure exchange of one or more messages between terminal devices in a network connecting said terminal devices, wherein the method comprises:
creating a message by a first terminal device;
digitally signing the message with a private key of the first terminal device; and
transmitting the signed message to at least a second terminal device;
wherein the creating the message to be transmitted and the digital signing by the first terminal device occur before an event relating to an intended interworking of the terminal devices triggers the transmission of the signed message; and wherein a content of the created message to be evaluated by the second terminal device is related to the event.

2. The method of claim 1, wherein the first terminal device comprises a sensor; and wherein the event corresponds to a changed state in an environment as detected by the sensor.

3. The method of claim 1, further comprising precalculating the event and/or the message relating to the event by the first terminal device.

4. The method of claim 3, wherein the precalculating occurs by creating a list of essentially possible events or messages and by selecting from said list, through comparison with the last-occurring event or the last-transmitted message, the event which is certain to occur or which will occur at least with a minimum probability as the next event or the message relating thereto.

5. The method of claim 1, further comprising storing the signed message relating to the event until the occurrence of the event, and retrieving the message and transmitting it to the second terminal device when the event occurs.

6. The method of claim 1, wherein creating and signing the message occur either:
immediately after a further message relating to a preceding event has first been dispatched, or
during an idle phase between the dispatch of two messages.

7. The method of claim 1, wherein the first terminal device, the second terminal device, and the network connecting the first terminal device and the second terminal device form a group for secure communication; wherein the group is part of a smart building automation and/or lighting system; wherein the transmitting the signed message from the first terminal device occurs in a multicast to the second terminal device and all further terminal devices.

8. The method of claim 7, wherein the first terminal device comprises a sensor; wherein the sensor is further configured to detect a presence of persons in an environment of the presence detector; wherein the second terminal device comprises a light configured to operate based on messages from the sensor;
wherein the event corresponds to the detection of the entry or exit of one or more persons into or from the environment of the sensor; and
wherein, in the case where a last-occurring event corresponds to the detection of the entry of the one or more persons, the first terminal device then selects a complementary event corresponding to the detection of the exit of the one or more persons from the environment before it occurs, as the next event to occur for which the message is to be created.

9. The method of claim 7, wherein the first terminal device comprises a sensor configured to indicate a temperature; wherein the second terminal device comprises an air conditioning system configured to operate based on messages from the sensor;
wherein the event corresponds to a change of a predefined temperature limit value;
wherein the first terminal device is configured to precalculate, through extrapolation, the next event to occur for which the message is to be created, before it occurs, from at least one last-occurring event of detecting that a further change of the predefined temperature limit value has occurred.

10. The method of claim 1, wherein messages are exchanged within the network at the application layer in accordance with the Constrained Application Protocol (CoAP) defined in RFC7252, based on the transport layer according to the User Datagram Protocol (UDP) defined in RFC768.

11. The method of claim 10, wherein the message is digitally signed with a signature algorithm based on elliptic curves.

12. The method of claim 7, wherein the digitally signed message is encrypted with a public key accessible to all terminal devices in the group.

13. The method of claim 1, further comprising:
receiving the digitally signed message by the second terminal device; and
verifying the digital signature of the first terminal device,
creating a further message, by the second terminal device, relating to the response to the digitally signed message from the first terminal device; and
signing the further message digitally before the second terminal device receives the digitally signed message from the first terminal device, and wherein the further digitally signed message is transmitted to the first terminal device based on the reception of the digitally signed message from the first terminal device.

14. The method of claim 13, wherein the further digitally signed message is a simple acknowledgement of receipt of the digitally signed message from the first terminal device without payload.

15. A terminal device for the secure exchange of one or more messages with one or more further terminal devices in a network connecting said terminal devices, wherein the terminal device is configured to:
create a message;
digitally sign the message with a private key;
transmit the digitally signed message to at least a second terminal device;
wherein the terminal device is configured to create and digitally sign the message to be transmitted before an event relating to an intended interworking of the terminal devices triggers the transmission of the signed message; and
wherein a content of the created message to be evaluated by the one or more further terminal devices is related to the event.

16. The terminal device of claim 15, wherein the terminal device is further configured to precalculate the subsequent occurring event and/or the message relating to the event.

17. The terminal device of claim 16, wherein the terminal device is further configured to perform the precalculation, the creation, and the digital signing of the message in an idle phase of the first terminal device.
